(19) United States
(12) Patent Application Publication
(10) Pub. No.: US 2026/0348339 A1
(43) Pub. Date: Nov. 5, 2026

(54) SELF-CONTAINED THRUST ENGINE

(71) Applicant: Allen John Pawlowski, Glen Ellyn, IL (US)

(72) Inventor: Allen John Pawlowski, Glen Ellyn, IL (US)

(21) Appl. No.: 19/439,801

(22) Filed: Jan. 5, 2026

Related U.S. Application Data
(60) Provisional application No. 63/798,087, filed on May 1, 2025.

(51) Int. Cl. F02K 1/00; B64G 1/28; B64G 1/40; F03G 3/08; H01F 7/08

(52) U.S. Cl. CPC F02K 1/002; B64G 1/28; B64G 1/409; F03G 3/08; H01F 7/08

(57) ABSTRACT

A self-contained thrust engine generates propulsion through mechanically induced precession of spinning flywheels mounted on continuously rotating moment arms. The system includes a central drive motor that rotates at least one moment arm in a continuous circular path. Flywheel assemblies mounted at distal ends of the moment arms include spinning flywheels that are selectively locked in rigid alignment with the moment arms during predefined arc segments using a maintenance-free magnetic braking system comprising permanent magnets and electromagnets. During these segments, forced precession of the spinning flywheels generates reaction forces that produce thrust. A rotatably adjustable cam mechanism controls the angular position of the precession segments, providing 360-degree thrust direction control while the engine remains stationary. The continuous circular motion eliminates vibrations associated with reciprocating systems and improves power-to-thrust efficiency, making the system suitable for spacecraft and satellite applications.

### CROSS-REFERENCE TO RELATED APPLICATION

This application claims the benefit of priority under 35 U.S.C. § 119(e) to U.S. Provisional Patent Application No. 63/798,087, filed May 1, 2025, entitled “SELF-CONTAINED THRUST ENGINE,” the entire disclosure of which is incorporated herein by reference.

### FIELD OF THE INVENTION

The present invention relates generally to propulsion systems and, more particularly, to a self-contained mechanical thrust generation system utilizing gyroscopic precession of rotating flywheels for spacecraft maneuvering and attitude control.

### BACKGROUND OF THE INVENTION

The field of spacecraft propulsion and attitude control has long relied on chemical propulsion systems that operate by expelling reaction mass. While effective, such systems have inherent limitations including finite fuel supplies, complexity of fuel storage and handling, and the need for periodic refueling or replacement. These limitations become particularly significant for long-duration space missions, satellites requiring extended operational lifetimes, and applications where minimal mass ejection is desired.

Various concepts have been proposed for generating thrust through mechanical means rather than mass ejection. These concepts generally involve the manipulation of spinning masses, such as flywheels or gyroscopes, to generate reaction forces.

The underlying principle involves the gyroscopic properties of rotating masses, particularly the phenomenon of precession that occurs when torque is applied perpendicular to the spin axis of a rotating body.

For example, U.S. Patent Publication No. 2012/0024633A1 describes a system in which gyroscopes mounted on moment arms are cycled in a back-and-forth rowing motion to drive a spacecraft. The gyroscope inertial properties are configured to provide maximum resistance torque during a drive stroke and minimum torque resistance during a return stroke. The disclosure suggests that the torques and forces generated by changes in gyroscope spin axis orientation during moment arm rotation can provide propulsion analogous to rowing a boat.

While such prior art systems demonstrate the theoretical possibility of mechanical thrust generation, they suffer from several practical limitations that have prevented their adoption by the space industry. First, the reciprocating back-and-forth motion of moment arms creates significant vibrational forces that can interfere with sensitive spacecraft systems and degrade structural integrity over time. Second, the cyclical nature of the back-and-forth motion results in inefficient power-to-thrust conversion, with substantial energy losses during acceleration and deceleration phases. Third, existing concepts lack effective means for controlling thrust direction without physically reorienting the entire propulsion assembly, limiting maneuverability options.

These limitations have prevented the practical implementation of mechanically based thrust systems despite their theoretical advantages over chemical propulsion in terms of longevity and the ability to refuel.

There exists a need in the art for a mechanical thrust generation system that overcomes the limitations of prior approaches by providing continuous rather than reciprocating motion to reduce vibrational forces; improved efficiency in converting electrical power to thrust; maintenance-free operation suitable for extended space missions; and versatile thrust direction control without requiring physical reorientation of the propulsion assembly.

### SUMMARY OF THE INVENTION

The present invention addresses shortcomings with conventional systems and methods by providing a self-contained thrust engine that generates propulsion through mechanically induced precession of spinning flywheels mounted on continuously rotating moment arms.

In one aspect, the invention provides a thrust generation system comprising a support frame, a central motor operatively connected to a drive mechanism, at least one moment arm rotatably mounted to the drive mechanism and configured to rotate in a continuous circular path about a central axis, at least one flywheel assembly mounted at a distal end of the moment arm with each flywheel assembly comprising a flywheel rotatable about its own spin axis, and a precession control system configured to induce precession of the flywheel assembly during a predefined arc segment of the moment arm's rotation. The circular motion of the moment arm replaces reciprocating back-and-forth motion, thereby reducing vibrational forces and improving power-to-thrust efficiency during operation.

In another aspect, the invention provides a maintenance-free magnetic braking system for controlling precession timing. The braking system comprises a brake disc mounted to the flywheel assembly and including a plurality of permanent magnets spaced at regular intervals, an electromagnet fixed relative to the moment arm and positioned to magnetically engage with the permanent magnets on the brake disc, and a control system configured to activate the electromagnet during a predefined arc segment to restrain rotation of the flywheel assembly and induce precession, and to deactivate the electromagnet outside the arc segment to permit free rotation. The braking system operates without frictional contact and is configured for low-maintenance operation in a space environment.

In yet another aspect, the invention provides a thrust direction control system comprising a rotatable moment arm configured to support a flywheel assembly, a braking system operable to selectively restrain rotation of the flywheel assembly during a predefined arc segment of the moment arm's rotation to induce precession, and a cam mechanism mounted to a fixed portion of the engine frame and positioned around a drive shaft of the moment arm. The cam is rotatably adjustable relative to the drive shaft and configured to control activation of the braking system based on the angular position of the moment arm, thereby allowing the predefined arc segment in which thrust is generated to be positioned at any angle around the drive shaft, providing full 360-degree thrust direction control while the engine remains fixed in place.

The system preferably includes at least two moment arms configured to rotate in opposite directions and synchronized with each other to balance rotational forces. More preferably, the system includes three or more moment arms arranged to provide continuous thrust with reduced pulsation.

These and other features, aspects, and advantages of the present invention will become better understood with reference to the following drawings, detailed description, and claims.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a top plan view of a self-contained thrust engine in accordance with an embodiment of the present invention, showing the main support frame, drive motor, moment arms, flywheel assemblies, and the precession arc positions;

FIG. 2 is a side elevation view of the thrust engine of FIG. 1, illustrating the vertical arrangement of components including the main drive motor, power delivery slip rings, and the thrust direction control cam;

FIG. 3 is a bottom plan view of the magnetic braking system in accordance with an embodiment of the present invention, showing the arrangement of permanent magnets, electromagnet, control switch, and thrust direction control cam;

FIG. 4 is a side elevation view, partially in section, of the magnetic braking system of FIG. 3, illustrating the vertical relationship between the permanent magnets, electromagnet, control switch, cam, and slip ring assembly; and

FIG. 5 is a schematic diagram illustrating flywheel axis orientation during one complete circular rotation of a moment arm, showing the −60-degree precession arc and the free rotation orientation throughout the remainder of the circle, with an arrow indicating the direction of thrust generation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention. The scope of the invention is best defined by the appended claims.

### System Overview

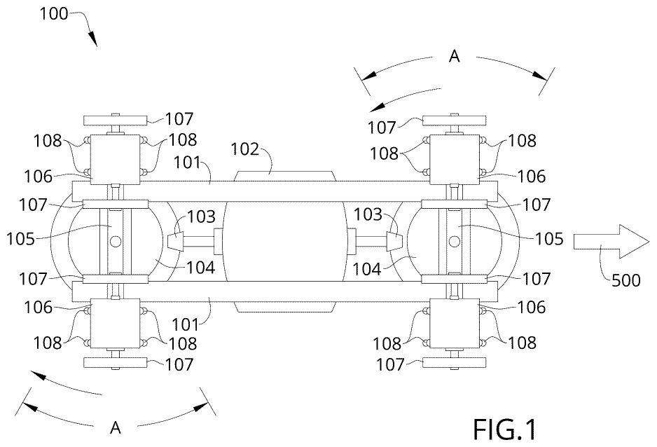

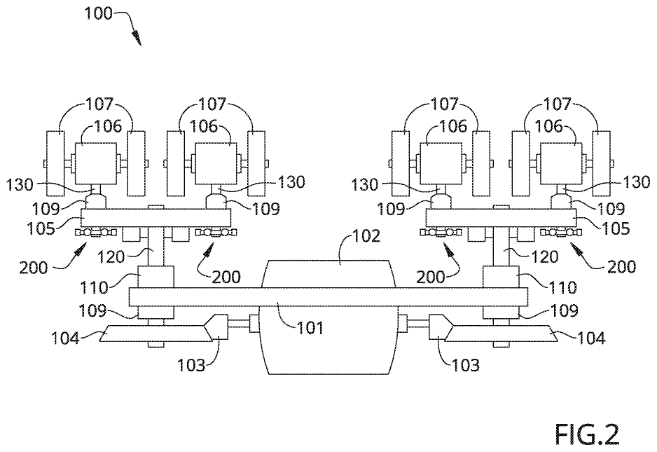

Referring now to the drawings, and particularly to FIGS. 1 and 2, there is shown a self-contained thrust engine 100 in accordance with a preferred embodiment of the present invention. The thrust engine 100 comprises a main support frame 101, a centrally located main drive motor 102, a drive mechanism for transmitting rotational motion, at least one moment arm 105 (preferably two counter-rotating moment arms as illustrated), flywheel assemblies comprising flywheel drive motors 106 and flywheels 107, and a precession control system including a magnetic braking system 200 and thrust direction control cam 110.

The main support frame 101 provides structural support for all components of the thrust engine 100 and is configured to be mounted to a spacecraft, satellite, or other vehicle requiring propulsion or attitude control. The frame 101 may be constructed from lightweight, high-strength materials such as aluminum alloy, titanium, or composite materials suitable for space applications.

The main drive motor 102 is horizontally mounted at the center of the frame 101 and comprises a dual-shaft electric motor with output shafts extending in opposite directions. In the illustrated embodiment, small, beveled pinion gears 103 are attached to each end of the motor shafts. These pinion gears 103 engage corresponding main drive gears 104, which are larger in diameter than the pinion gears 103 to provide speed reduction. The main drive gears 104 are mounted to vertical drive shafts that extend upward through the frame 101. This arrangement provides synchronized rotation of the moment arms 105 in counter-rotating directions, which serves to balance rotational torques and minimize net angular momentum imparted to the spacecraft.

### Moment Arm Configuration

Each moment arm 105 is centered on and fixed to one of the vertical drive shafts, such that rotation of the main drive gears 104 causes the moment arms 105 to rotate in a continuous circular path about a central vertical axis. The moment arms 105 preferably extend radially outward from their respective drive shafts and are configured to rotate in a substantially horizontal plane.

At the distal end of each moment arm 105 is mounted a free-swinging vertical shaft that supports a flywheel assembly. This vertical shaft is rotatably mounted to the moment arm 105 such that it can freely rotate about its own vertical axis while being carried along the circular path defined by the rotation of the moment arm 105. The vertical shaft extends both above and below the moment arm 105.

### Flywheel Assembly

Mounted on the upper portion of each free-swinging vertical shaft is a flywheel assembly comprising a flywheel drive motor 106 and one or more flywheels 107. In the illustrated embodiment, each flywheel drive motor 106 comprises a dual-shaft electric motor with flywheels 107 mounted on both ends of the motor shaft, providing balanced rotation. The flywheels 107 are configured to spin at high rotational speeds about their spin axes, which are aligned with the free-swinging vertical shafts. The mass, diameter, and rotational speed of the flywheels 107 are selected to provide desired gyroscopic properties, including angular momentum and resistance to precession.

The flywheel drive motors 106 receive electrical power through a power delivery system that accommodates the continuous rotation of the moment arms 105. As shown in FIG. 2, power delivery slip rings 109 provide electrical connections that allow current to flow from stationary power sources to the rotating moment arms 105 and flywheel assemblies.

### Magnetic Braking System

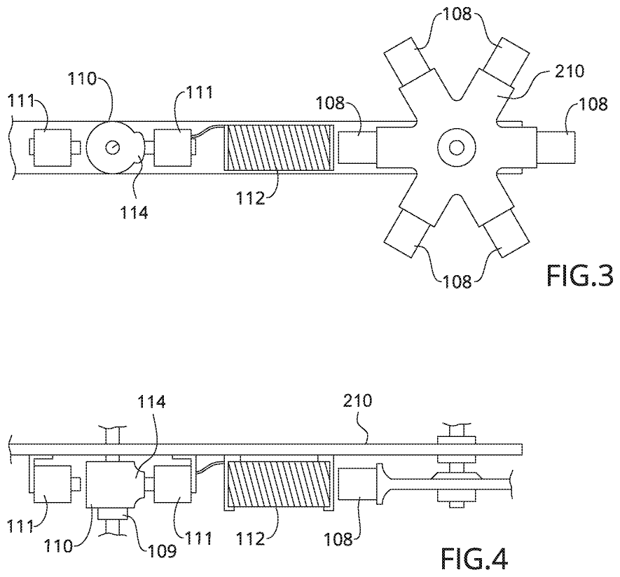

Referring now to FIGS. 3 and 4, the magnetic braking system 200 is mounted on the lower portion of each free-swinging vertical shaft, below the moment arm 105. The braking system 200 comprises a brake disc that rotates with the free-swinging vertical shaft and includes a plurality of permanent magnets 108 mounted thereon. In the illustrated embodiment, six permanent magnets 108 are spaced at 60-degree intervals around the periphery of the brake disc.

An electromagnet 112 is fixed to the underside of the moment arm 105 in a position to engage with the permanent magnets 108 on the rotating brake disc. When electrical current flows through the electromagnet 112, it generates a magnetic field that attracts and captures an adjacent permanent magnet 108, thereby preventing further rotation of the brake disc and, consequently, the free-swinging vertical shaft and the flywheel assembly mounted thereon. This magnetic coupling locks the flywheel assembly in rigid alignment with the moment arm 105.

When the electromagnet 112 is deactivated (i.e., when current flow ceases), the magnetic attraction is eliminated, and the brake disc is released, allowing the free-swinging vertical shaft and flywheel assembly to rotate freely about their vertical axis.

This magnetic braking system operates without any frictional contact between components, thereby eliminating wear and the need for periodic maintenance-a significant advantage for space applications where access for repairs is limited or impossible.

### Precession Control System

The timing of the electromagnetic brake activation and deactivation is controlled by a switch system 111 that is actuated by the thrust direction control cam 110. As shown in FIGS. 2, 3, and 4, the control cam 110 is mounted on the main support frame 101 around the vertical drive shafts. The cam 110 includes a raised lobe or projection that extends over a predefined arc segment, which in the illustrated embodiment is approximately 60 degrees of arc.

An electromagnet braking control switch 111 is mounted to each moment arm 105 in a position to contact the raised lobe of the cam 110 as the moment arm rotates. When the switch 111 encounters the raised lobe, it closes, allowing current to flow to the electromagnet 112, which then captures a permanent magnet 108 and locks the flywheel assembly in rigid alignment with the moment arm 105. When the moment arm 105 rotates beyond the lobe, the switch 111 opens, current flow ceases, the electromagnet 112 deactivates, and the flywheel assembly is released to rotate freely.

### Operation and Thrust Generation

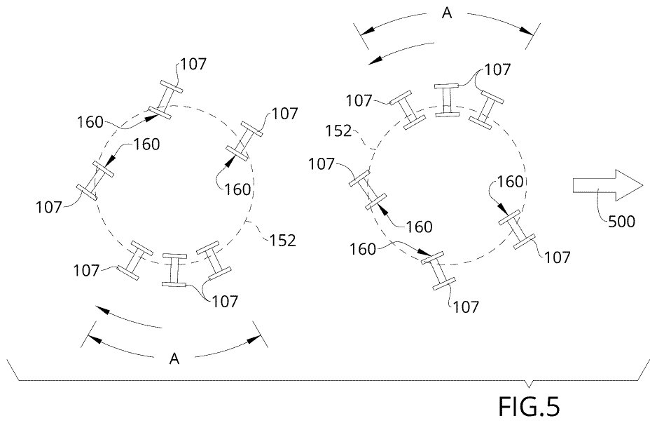

The principle of thrust generation will now be described with reference to FIG. 5, which schematically illustrates the orientation of a flywheel 107 during one complete circular rotation of its moment arm 105.

During operation, the main drive motor 102 causes the moment arms 105 to rotate continuously in opposite directions at a selected rotational speed. The flywheel drive motors 106 maintain the flywheels 107 at high rotational speeds about their spin axes. As each moment arm 105 rotates, it carries its associated flywheel assembly along a circular path.

Throughout most of the circular path (indicated by reference numeral 160 in FIG. 5), the flywheel assembly is free to rotate about its vertical shaft, and the flywheel spin axis maintains a substantially constant angular orientation in space, similar to a gyrocompass. This behavior is due to the gyroscopic stability of the spinning flywheel.

However, during a predefined arc segment of each rotation (indicated by reference numeral A in FIG. 5, which shows a 60-degree precession arc), the magnetic braking system 200 is activated, locking the flywheel assembly in rigid alignment with the moment arm 105. During this arc segment, as the moment arm 105 continues to rotate, the locked flywheel assembly is forced to change its angular orientation. This forced change in orientation of the spinning flywheel constitutes precession, and the flywheel resists this precession due to its angular momentum.

The resistance to precession generates a reaction torque that acts on the moment arm 105 and, through the drive mechanism, is transmitted to the main support frame 101. This reaction torque has a component in a linear direction (indicated by arrow 500 in FIGS. 1 and 5), which constitutes thrust. The direction of this thrust is perpendicular to both the spin axis of the flywheel and the axis about which precession is being forced.

By positioning the precession arc segment (the location where the braking system is activated) at a right angle to the desired thrust direction, the system generates thrust in the desired direction. The magnitude of thrust generated during each precession arc is a function of the angular momentum of the flywheels, the rate of precession (which depends on the moment arm rotational speed), and the duration of the precession arc.

After the moment arm 105 rotates beyond the precession arc segment, the electromagnet 112 is deactivated, releasing the flywheel assembly to rotate freely. During this free rotation period, which occupies the majority of each revolution, the flywheel drive motors 106 have time to restore any rotational speed (RPM) lost during the precession phase, maintaining consistent flywheel angular momentum for subsequent precession cycles.

### Multiple Moment Arms for Continuous Thrust

In the embodiment illustrated in FIGS. 1 and 2, the system includes two moment arms 105 rotating in opposite directions. With a 60-degree precession arc for each moment arm, and with the moment arms synchronized such that they are 180 degrees out of phase, the system generates thrust pulses at intervals during operation. Each moment arm produces thrust during one-sixth of its rotation cycle.

To provide smoother, more continuous thrust, the system can be configured with three or more moment arms. For example, with three moment arms spaced 120 degrees apart and each having a 60-degree precession arc, the system would generate overlapping thrust pulses that approximate continuous thrust. Similarly, configurations with four, five, six, or more moment arms can be implemented to achieve desired thrust profiles.

### Thrust Direction Control

A significant advantage of the present invention is the ability to control thrust direction without physically reorienting the entire propulsion assembly. This is achieved through the adjustable thrust direction control cam 110.

As shown in FIGS. 2, 3, and 4, the cam 110 is mounted to the main support frame 101 in a manner that allows it to be rotated about the vertical drive shafts. By rotating the cam 110, the angular position of the raised lobe (and thus the location of the precession arc segment) can be adjusted to any angle around the circle of moment arm rotation. Since the direction of thrust is determined by the angular position of the precession arc, adjusting the cam position provides 360-degree control over thrust direction.

For example, if thrust in a northward direction is desired, the cam 110 is positioned such that the precession arc occurs when the moment arms are in the east-west positions. To change thrust direction to eastward, the cam 110 is rotated 90 degrees, shifting the precession arc to occur when the moment arms are in the north-south positions.

This steering capability can be implemented manually (for planned maneuvers) or through an automated control system that adjusts cam position in response to navigation commands or feedback from attitude sensors. The cam positioning mechanism may include a motor-driven actuator, a gear system, or other suitable means for rotating the cam 110 to desired angular positions.

### Alternative Embodiments and Modifications

While the foregoing description has focused on a preferred embodiment, various modifications and alternative configurations are within the scope of the invention.

The number of flywheels mounted on each flywheel assembly can be varied. The illustrated embodiment shows two flywheels per assembly (one on each end of a dual-shaft motor), but single flywheel configurations or multiple flywheel configurations with more than two flywheels are contemplated.

The angular extent of the precession arc can be adjusted to optimize performance. While a 60-degree arc is described in the preferred embodiment, arcs ranging from approximately 30 degrees to 120 degrees may be suitable depending on system parameters. Shorter arcs reduce the duty cycle of precession, allowing more time for flywheel speed restoration but producing lower average thrust. Longer arcs increase the duty cycle, potentially increasing average thrust but requiring more powerful flywheel drive motors to maintain speed during extended precession periods.

The number and spacing of permanent magnets on the brake disc can be varied. The six magnets at 60-degree intervals described in the preferred embodiment are well-suited for a 60-degree precession arc, but other configurations may be employed. More magnets at closer spacing provide finer control over brake engagement timing, while fewer magnets simplify construction.

The main drive motor 102 and drive mechanism can take various forms. While the illustrated embodiment uses beveled pinion gears engaging larger drive gears, alternative drive mechanisms such as belt drives, chain drives, or direct-drive motors for each moment arm may be employed.

The system can be scaled to various sizes depending on the application. Small-scale units may be suitable for attitude control of micro-satellites, while larger units may provide primary propulsion for spacecraft. The scaling considerations primarily involve flywheel mass and diameter, moment arm length, and rotational speeds.

### Advantages Over Prior Art

The present invention provides several significant advantages over prior art mechanical thrust generation systems:
First, the continuous circular rotation of moment arms, as opposed to reciprocating back-and-forth motion, substantially reduces vibrational forces. This makes the system more compatible with sensitive spacecraft systems and reduces structural stress.
Second, the continuous rotation improves efficiency in converting electrical power to thrust. Unlike reciprocating systems that must repeatedly accelerate and decelerate moment arms, wasting energy in each cycle, the present system maintains steady-state rotation with energy input primarily directed to overcoming the resistance during precession and maintaining flywheel speeds.
Third, the magnetic braking system eliminates friction-based components that would require periodic maintenance. This is particularly important for space applications where maintenance opportunities are extremely limited. The magnetic system can operate reliably for extended periods without degradation. This does not preclude the use of mechanical braking systems where limited use is anticipated.
Fourth, the variable cam positioning provides 360-degree thrust direction control while the main propulsion assembly remains stationary. This eliminates the need for gimbaling or physically reorienting the propulsion unit, simplifying spacecraft design and reducing complexity.
Fifth, the modular design allows for redundancy and scalability. Multiple thrust engines can be installed on a spacecraft for redundancy, and the number of moment arms per engine can be selected to provide desired thrust characteristics.

### Materials and Construction

The components of the thrust engine 100 are preferably constructed from materials suitable for space environments, including resistance to vacuum, radiation, and thermal cycling. The main support frame 101, moment arms 105, and structural components may be fabricated from aluminum alloys, titanium alloys, or advanced composites. The flywheels 107 are preferably constructed from high-density materials to maximize angular momentum for a given diameter, and may incorporate materials such as steel, tungsten, or depleted uranium (in appropriate shielding). The flywheel drive motors 106 and main drive motor 102 are preferably brushless DC motors or other motor types suitable for long-life operation in vacuum. The permanent magnets 108 are preferably high-strength rare-earth magnets such as neodymium-iron-boron (NdFeB) or samarium-cobalt (SmCo) magnets. The electromagnet 112 comprises a coil wound on a ferromagnetic core, with the coil preferably incorporating vacuum-compatible insulation.

The foregoing detailed description has presented a self-contained thrust engine that overcomes significant limitations of prior art mechanical propulsion systems. Through the combination of continuous circular moment arm rotation, maintenance-free magnetic braking, and adjustable thrust direction control, the invention provides a practical solution for spacecraft maneuvering and attitude control with advantages over conventional chemical propulsion systems.

It should be understood, of course, that the foregoing relates to exemplary embodiments of the invention and that modifications may be made without departing from the spirit and scope of the invention as set forth in the following claims.

1. A thrust generation system comprising:
a support frame;
a central motor operatively connected to a drive mechanism;
at least one moment arm rotatably mounted to the drive mechanism and configured to rotate in a continuous circular path about a central axis;
at least one flywheel assembly mounted at a distal end of the moment arm, each flywheel assembly comprising a flywheel rotatable about its own spin axis; and
a precession control system configured to induce precession of the flywheel assembly during a predefined arc segment of the moment arm's rotation, wherein the circular motion of the moment arm reduces vibrational forces and improves power-to-thrust efficiency during operation.

2. The thrust generation system of claim 1, further comprising at least two moment arms configured to rotate in opposite directions and synchronized with each other.

3. The thrust generation system of claim 2, wherein the drive mechanism comprises: a dual-shaft motor with pinion gears on each end; two main drive gears engaging the pinion gears; and vertical drive shafts connected to the main drive gears and to the moment arms.

4. The thrust generation system of claim 1, wherein the flywheel assembly is mounted on a free-swinging vertical shaft that is rotatably connected to the distal end of the moment arm.

5. The thrust generation system of claim 1, wherein each flywheel assembly comprises a flywheel drive motor and at least one flywheel mounted thereon.

6. The thrust generation system of claim 5, wherein the flywheel drive motor is a dual-shaft motor with flywheels mounted on both ends thereof.

7. The thrust generation system of claim 1, wherein the predefined arc segment comprises approximately 30 to 120 degrees of the moment arm's rotation.

8. The thrust generation system of claim 1, wherein the predefined arc segment comprises approximately 60 degrees of the moment arm's rotation.

9. The thrust generation system of claim 1, wherein the precession control system comprises a braking system configured to selectively restrain rotation of the flywheel assembly during the predefined arc segment.

10. A braking system for controlling precession in a thrust engine comprising:
a moment arm rotatable about a central axis;
a flywheel assembly mounted at a distal end of the moment arm and configured to rotate about a secondary axis;
a brake disc mounted to the flywheel assembly and including a plurality of permanent magnets spaced at regular intervals;
an electromagnet fixed relative to the moment arm and positioned to magnetically engage with the permanent magnets on the brake disc; and
a control system configured to activate the electromagnet during a predefined arc segment of the moment arm's rotation to restrain rotation of the flywheel assembly and induce precession, and to deactivate the electromagnet outside the arc segment to permit free rotation of the flywheel assembly, wherein the braking system operates without frictional contact.

11. The braking system of claim 10, wherein the plurality of permanent magnets comprises six magnets spaced at 60-degree intervals around the brake disc.

12. The braking system of claim 10, wherein the control system comprises:
a cam mechanism mounted to a fixed portion of an engine frame and including a raised lobe extending over the predefined arc segment; and
a switch mounted to the moment arm and configured to engage the raised lobe, wherein engagement of the switch with the raised lobe activates the electromagnet.

13. The braking system of claim 12, wherein the cam mechanism is rotatably adjustable to change the angular position of the predefined arc segment.

14. The braking system of claim 10, wherein the permanent magnets comprise rare-earth magnets.

15. A thrust direction control system for a thrust engine comprising:
a rotatable moment arm configured to support a flywheel assembly;
a braking system operable to selectively restrain rotation of the flywheel assembly during a predefined arc segment of the moment arm's rotation to induce precession; and
a cam mechanism mounted to a fixed portion of an engine frame and positioned around a drive shaft of the moment arm,
wherein the cam mechanism is rotatably adjustable relative to the drive shaft and configured to control activation of the braking system based on the angular position of the moment arm, thereby allowing the predefined arc segment in which thrust is generated to be positioned at any angle around the drive shaft, providing 360-degree thrust direction control.

16. The thrust direction control system of claim 15, wherein the cam mechanism comprises a raised lobe extending over an arc corresponding to the predefined arc segment.

17. The thrust direction control system of claim 15, wherein adjustment of the cam mechanism changes the direction of thrust without requiring physical reorientation of the engine frame.

18. The thrust direction control system of claim 15, further comprising an actuator configured to automatically adjust the angular position of the cam mechanism in response to navigation commands.
